(19) United States
(12) Patent Application Publication
(10) Pub. No.: US 2014/0249006 A1
(43) Pub. Date: Sep. 4, 2014

(54) PAINT ROLLER END CAP

(71) Applicant: Arigala Painting, Inc., Castaic, CA (US)

(72) Inventor: Jose Antonio Gallardo, Castaic, CA (US)

(73) Assignee: Arigala Painting, Inc., Castaic, CA (US)

(21) Appl. No.: 14/278,557

(22) Filed: May 15, 2014

Related U.S. Application Data
(63) Continuation-in-part of application No. 13/561,531, filed on Jul. 30, 2012, now Pat. No. 8,726,449.
Application No. 13/561,531 is a continuation-in-part of application No. 13/547,964, filed on Jul. 12, 2012.

(51) Int. Cl. B05C 17/02

(52) U.S. Cl. CPC B05C 17/0245
USPC 492/47

(57) ABSTRACT

A paint roller end cap for use with paint roller covers to keep a minimum spacing between the end of the paint roller cover and an adjacent surface to a painting surface. The end cap is configured for removable attachment to an exposed end of the paint roller cover. The end cap is either an annular ring for snug fit attachment to an end plug in the roller cover or a flat disk and stem for snug fit insertion into a central tube on the roller cover. The end cap includes one of a plurality of rib, a plurality of grooves, or a protruding disk to provide the minimum spacing from the adjacent surface.

### RELATED APPLICATIONS

This application is a continuation-in-part of U.S. application Ser. No. 13/561,531, filed Jul. 30, 2012, which application is a continuation-in-part of U.S. application Ser. No. 13/547,964, filed Jul. 12, 2012.

### BACKGROUND OF THE INVENTION

The present invention relates generally to paint rollers. More particularly this invention relates to end caps used on paint rollers to facilitate painting surfaces near or in corners or similarly tight areas.

Paint rollers allow a user to paint larger areas with less effort than is required with a traditional paint brush. A standard paint roller includes a wire frame with a handle and cantilevered roller arm. A roller cover is generally shaped as an elongated hollow cylinder covered in an absorbent material and is pushed in place over a wire cage situated around the cantilevered roller arm. The wire cage has a circumference that allows for a tight fit with the inner diameter of the roller cover. The user may roll the paint roller through a tray of paint until the absorbent material is saturated with the desired amount of paint. Alternatively, the paint roller may be pressurized such that paint is injected into the interior of the roller cover to ooze outward through the absorbent material. The paint roller is then rolled over the surface to be painted.

Roller covers typically are covered by absorbent material to the very edge of the elongated hollow cylinder. When painting in corners or other similarly confined areas, the absorbent material on the very edge will generally come into contact with the wall or other structure adjacent to the surface being painted. Since the absorbent material is saturated with paint, the edge portion of the absorbent material that comes into contact with the adjacent wall or structure will generally transfer paint to that adjacent wall or structure.

Thus, there is a need for an apparatus whereby a paint roller can be used to paint a surface in a corner or similarly confined area without transferring paint to the adjacent surface. The present invention fulfills this need and provides further related advantages.

### SUMMARY OF THE INVENTION

The present invention is directed to a paint roller end cap to maintain a minimum distance between a paint roller cover and an adjacent surface to a painting surface. The end cap includes a spacer cover configured for removable attachment to an exposed end of the paint roller cover. The end cap also includes means for removably attaching the spacer cover to the exposed end of the paint roller cover. A spacing extension is disposed on an outward surface of the spacer cover, wherein the outward surface faces the adjacent surface.

In one particular embodiment, the spacer cover is an annular ring configured for removable attachment to an end plug in the exposed end of the paint roller cover. The end plug may be a pressurized plug integral with the paint roller cover or an insertable plug. Both end plugs are preferably for use with standard size paint roller covers. The means for removably attaching the end cap includes an annular lip of the end plug extending from the exposed end of the paint roller cover. The annular lip is configured to receive the annular ring in a press fit or snap fit attachment. The spacing extension preferably is a plurality of ribs or grooves disposed around the outward surface of the annular ring. The plurality of ribs or grooves have a predetermined depth configured to maintain the exposed end of the paint roller cover the minimum distance away from the adjacent surface.

In a second particular embodiment, the spacer cover is a flat disk configured for removable attachment to a central tube on the paint roller cover, which central tube preferably comprises an open cylinder on a mini paint roller cover. The means for removably attaching is a stem configured for press fit or snap fit attachment in the central tube.

In one version of the second embodiment, the spacer extension is a plurality of ribs annularly disposed around the outward surface of the flat disk. In another version of this second embodiment, the spacer extension is a protruding disk extending from the outward surface of the flat disk. This protruding disk preferably includes a plurality of notches around a perimeter of the protruding disk.

Other features and advantages of the present invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of an adjustable length paint roller frame;

FIG. 2 is a close-up view of the roller arm and roller cover of FIG. 1 cut away to illustrate the placement of the roller cover lock and end cap;

FIG. 3 illustrates the direction of movement for the roller cover lock;

FIG. 4 illustrates the roller cover lock in use with a shorter cover;

FIG. 5 is an exploded perspective view of the adjustable length paint roller frame of FIG. 1 showing the preferred placement of the roller cover lock and end cap;

FIG. 6 is an exploded perspective view, illustrating the selection of end caps available for use with the roller cover and roller cover lock;

FIG. 7 is a perspective view of a smooth disk end cap fitted to the roller cover;

FIG. 8 is a perspective view of an absorbent covering end cap fitted to the roller cover;

FIG. 9 is a perspective view of an adjustable length roller guide end cap fitted to the roller cover;

FIG. 10 is a perspective view of a notched disk end cap fitted to the roller cover;

FIG. 11 is an exploded perspective view of the roller cover illustrating the adjustable length roller guide's placement in conjunction with the end cap;

FIG. 12 is a perspective view of the roller cover of FIG. 11, illustrating the adjustable length roller guide in use once attached to the end cap;

FIG. 13 is a sectional view taken along line 13-13 from FIG. 11, illustrating the placement of the inner screw when the roller guide is flush with the roller end cap;

FIG. 14 is a sectional view similar to FIG. 13, illustrating the placement of the inner screw after the roller guide is extended away from the roller end cap;

FIG. 15 is an exploded perspective view of an embodiment of the paint roller end cap of the present invention;

FIG. 16 is a partially assembled perspective view of the paint roller end cap of FIG. 15;

FIG. 17 is a fully assembled perspective view of the paint roller end cap of FIG. 15;

FIG. 18 is an exploded perspective view of another embodiment of the paint roller end cap of the present invention;

FIG. 19 is an assembled perspective view of the paint roller end cap of FIG. 18;

FIG. 20 is a perspective view of the paint roller end cap of FIG. 19 with a differently configured end cap;

FIG. 21 is an environmental view illustrating use of the paint roller end cap of FIG. 17; and

FIG. 22 is an environmental view illustrating use of the paint roller end cap of FIG. 19.

### DETAILED DESCRIPTION OF THE PREFERRED EMBODIMENT

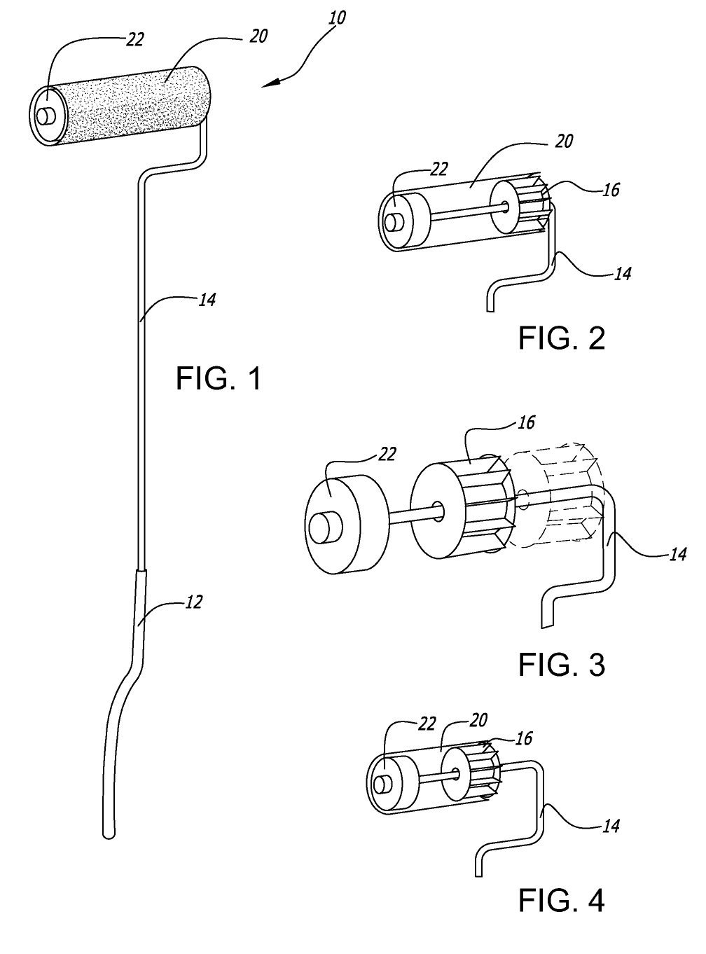

As shown in the exemplary drawings, an adjustable length paint roller frame, referred to generally in the figures by the reference numeral 10, is provided for more conveniently painting walls, pillars, chairs, fences and other surfaces. As shown in FIG. 1, the adjustable length paint roller frame 10 comprises a handle 12 and a roller arm 14. The roller arm 14 is mounted with a roller cover lock 16, a roller cover 20, and an end cap 22, as in FIG. 2.

FIG. 2 shows a cut-away view of the roller cover lock 16 and the end cap 22 in use with a roller cover 20. The roller cover lock 16 and end cap 22 serve to keep the roller cover 20 in place on the roller arm 14, and also prevent the roller cover 20 from collapsing against the roller arm 14. The roller cover lock 16 is rotatable about the roller arm 14, but is also slidable along the length of the roller arm 14, as shown in FIG. 3. The slidability of the roller cover lock 16 allows for the adjustable length paint roller frame 10 to be used with roller covers 20 of different sizes. In FIG. 4, a shorter roller cover 20 is shown in use with the roller cover lock 16 and the end cap 22.

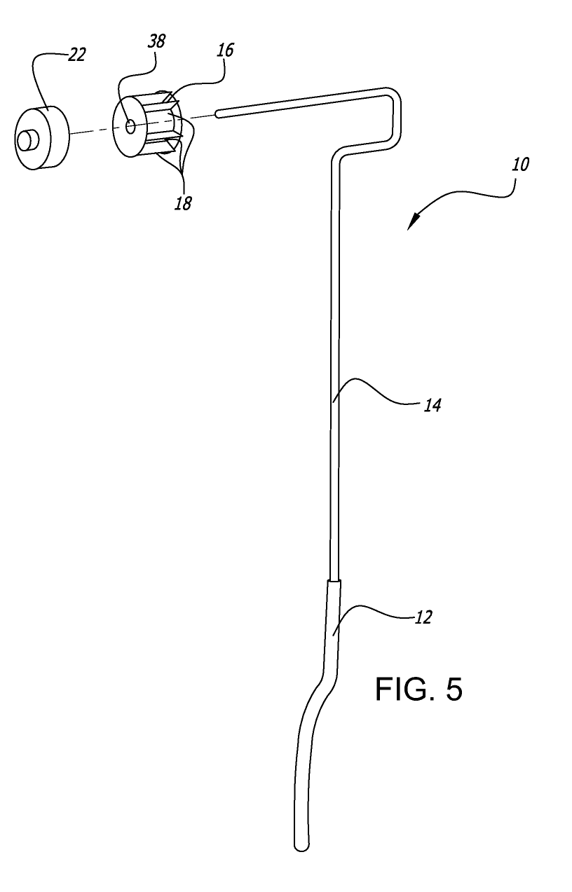

In FIG. 5, an exploded view of the adjustable length paint roller frame is shown, illustrating the preferred placement of the roller cover lock 16 and the end cap 22 on the roller arm 14. The roller cover lock 16 slides onto the roller arm first through a central aperture 38. The central aperture 38 is large enough to slide over the roller arm 14 and remain rotatable thereon. Next, a roller cover 20 is mounted on the roller arm 14 over the roller cover lock 16 (as shown in FIGS. 2 and 4). The roller cover lock 16 also features means 18 for enhancing the tight fit between the roller cover lock 16 and the roller cover 20. In the preferred embodiment, these means 18 are fins radiating from the center of the roller cover lock 16. The fins extend just beyond the outer circumference of the roller cover lock 16, and are made of a flexible material such as plastic, aluminum, tin, or the like. In other embodiments, the means 18 for enhancing the tight fit between the roller cover lock 16 and the roller cover 20 may be gripping teeth, or other similar means. Once a roller cover 20 is pushed over the roller cover lock 16, the means 18 interact with the interior of the roller cover 20 such that a very tight fit between the two is created. The placement of the roller cover 20 on the roller cover lock 16 is not permanent, but some force would be required to remove the roller cover 20 from the roller cover lock 16.

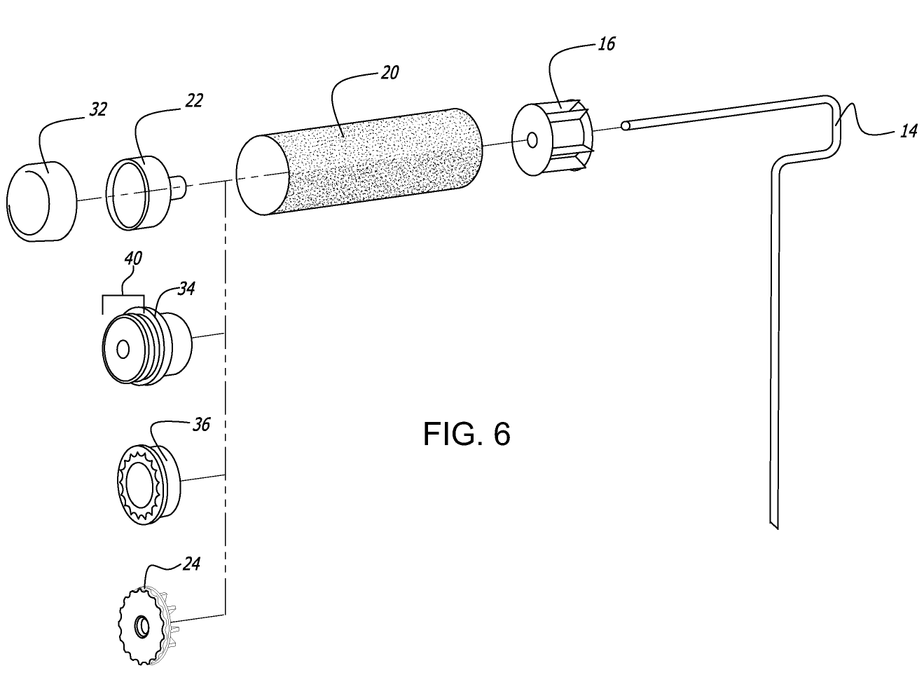

In FIG. 6, the roller arm 14, roller cover lock 16, and roller cover 20 are shown with the standard end cap 22 along with other end cap embodiments. The basic end cap 22 fits tightly within the interior of the roller cover 20 and attaches to the end of the roller arm 14. The end cap 22 may attach to the roller arm 14 with a screw, or with clips, clamps, or the like. The end cap 22 has a flat exterior side that is almost flush with the end of the roller cover 20 once in place. In another embodiment, any portion of the end cap 22 that extends beyond the end of the roller and can be covered with an absorbent cap 32. The absorbent cap 32 is made of similar material as found in the roller cover 20; namely, fabric, foam, lamb's wool or mohair. With the absorbent cap 32 in place, the adjustable length paint roller frame 10 can be used to paint into corners between two walls.

Other end cap embodiments are also illustrated in FIG. 6. The extended end cap 34 features a protruded portion 40 that extends beyond the end of the roller cover 20, when the extended end cap 34 is in place. The protruded portion 40 acts as a spacer that ensures the paint roller will not go past a certain distance toward a given object. For example, when painting around a window sill, the extended end cap 34 can be used. The adjustable length paint roller frame 10 can be guided along the edge of the window sill, but the paint will not be transferred onto the window sill because the extended end cap 34 spaces the roller cover 20 a given distance away from any given object.

Similarly, the notched end cap 36 is useful for edging when painting into a corner between two walls of different colors. The notched end cap 36 extends slightly beyond the end of the roller cover 20, allowing the roller cover 20 to come very close to the other wall without transferring paint onto the other wall. Alternately, the end cap can be an adjustable length roller guide 26, which allows for the roller cover 20 to be spaced a variable distance away from a given object, as described below.

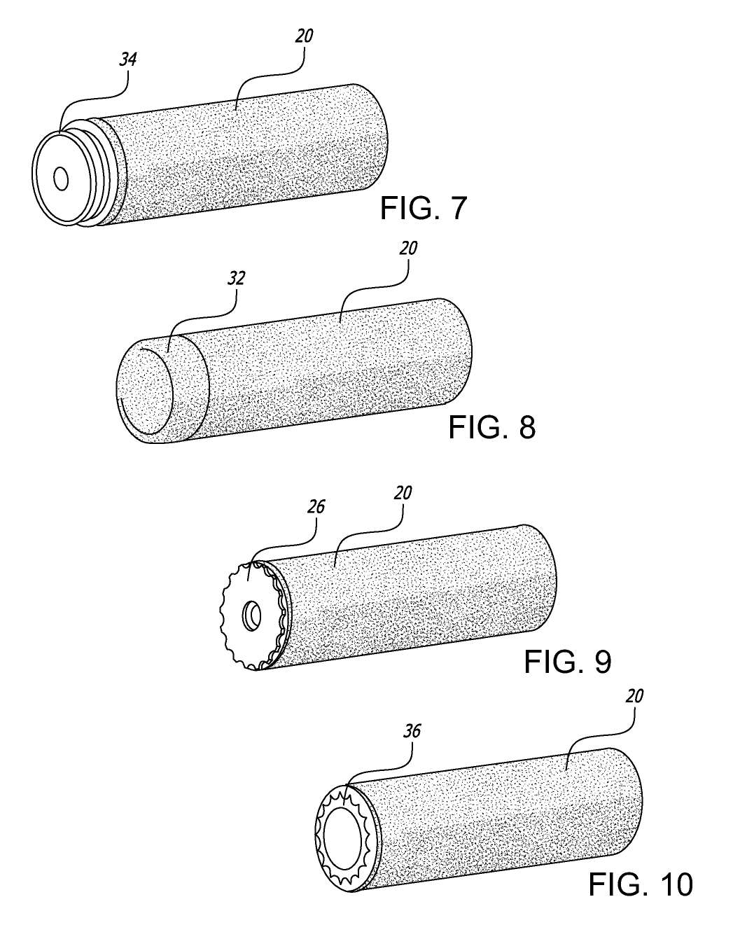

FIGS. 7-10 show the roller cover 20 in combination with the different end caps. In FIG. 7, the roller cover 20 is used in combination with the extended end cap 34. In FIG. 8, the end cap is covered with the absorbent cap 32. In FIG. 9, the roller cover 20 is used in combination with the adjustable length roller guide 26. And in FIG. 10, the roller cover 20 is used in combination with the notched end cap 36.

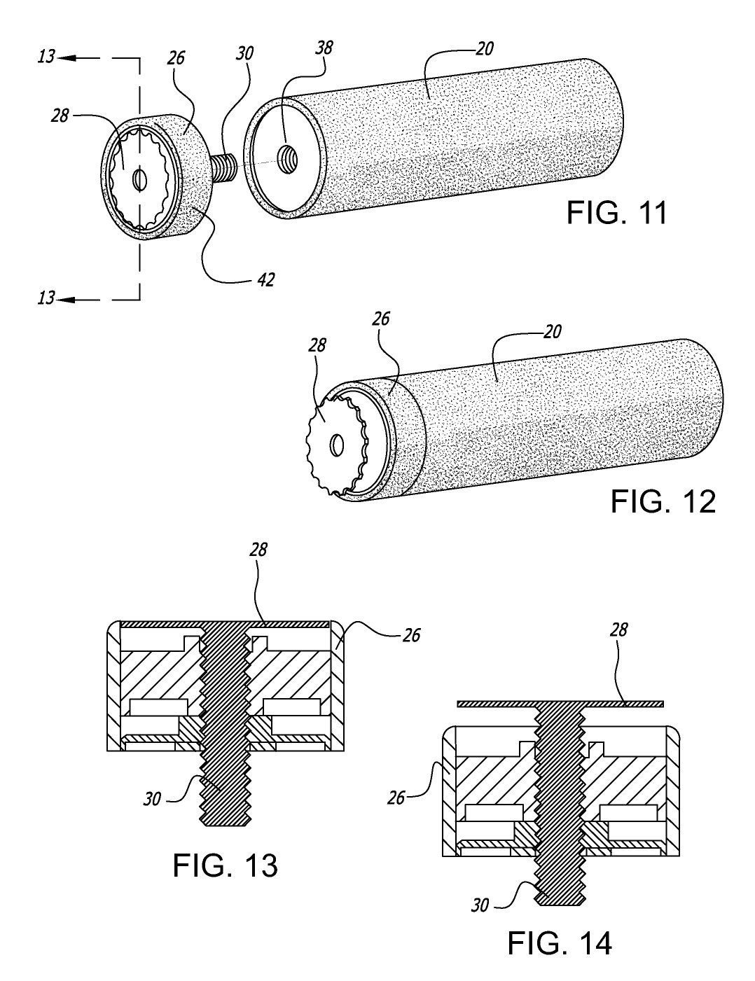

FIGS. 11-14 illustrate the adjustable length roller guide 26. In FIG. 11, the adjustable length roller guide 26 is shown with a screw on the interior side toward the roller cover 20, and a notched disk 28 on the exterior side away from the roller cover 20. In this embodiment, the adjustable length roller guide 26 is also partially covered in absorbent material 42. Much like the roller cover 20, this absorbent material 42 can be fabric, foam, lamb's wool or mohair. The screw 30 fits within the corresponding aperture 38 at the end of the roller cover 20. The adjustable length roller guide 26 is shown in place at the end of the roller cover 20 in FIG. 12. The notched disk 28 is extendable from the end of the roller cover 20 thereby creating a space between the roller cover 20, and anything that the roller cover 20 might be pushed against.

FIG. 13 is taken along line 13-13 in FIG. 11 and illustrates the screw 30 attached to the notched disk 28 inside the adjustable length roller guide 26. FIG. 14 shows that the notched disk 28 and attached screw can be extended from the end of the roller cover 20 without becoming detached from the roller cover 20. The adjustable length roller guide 26 allows for the roller cover 20 to be spaced a variable distance away from any object that the roller frame 10 is being guided along.

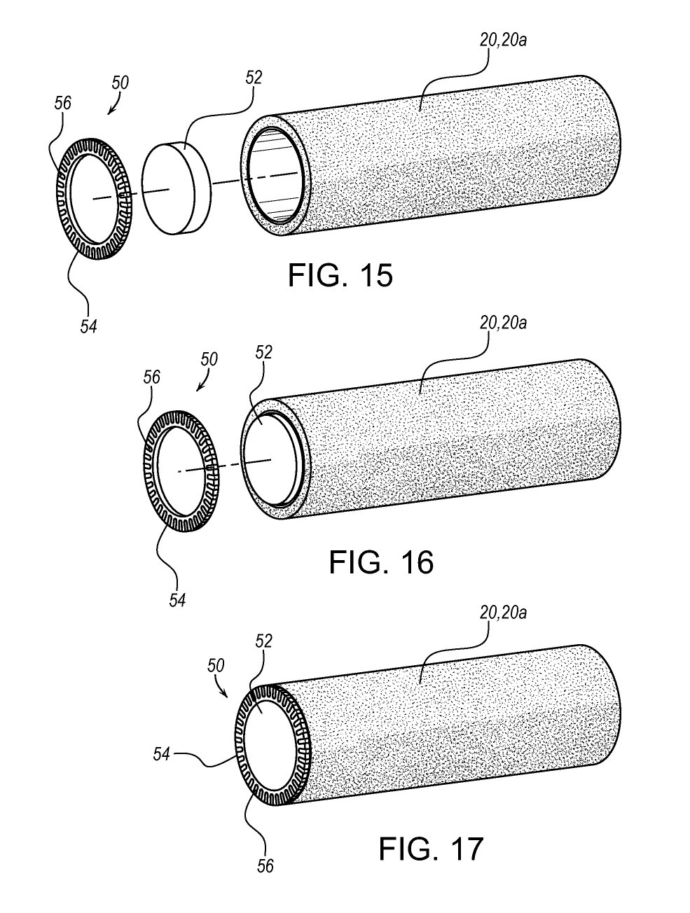

FIGS. 15-22 illustrate various embodiments and uses of the paint roller end cap 50 of the present invention. In a particularly preferred embodiment, the end cap 50 is designed to be used with an enclosed, pressurized paint roller 20a. FIG. 15 shows each of the main components of this embodiment in an exploded view. These components include the paint roller 20a, a plug 52 and a spacer ring 54. The pressurized paint roller 20a is typically sold with the plug 52 in place and is configured to accommodate a supply of paint pumped into the hollow interior of the roller 20a. The pumped paint then oozes out through the material of the hollow cylinder and any absorbent material covering the same. Apart from pressurized paint rollers 20a, a standard paint roller 20 may also be used with the end cap 50 of the present invention. In this instance, the plug 52 is attached to the paint roller 20 at the time of use of the end cap 50. As shown in FIG. 16, an annular lip 52a on the plug 52 generally protrudes from the end of the paint roller 20, 20a a minimum distance.

The spacer ring 54 is configured to slip over the annular lip 52a on the plug 52 protruding from the end of the paint roller 20, 20a. Exposed or outward surfaces on the plug 52 and ring 54 may be flush with one another when installed on the paint roller 20, 20a. Alternatively, the ring 54 may protrude slightly beyond the plug 52 so as to allow for adjustment of the minimum distance from the adjacent surface as described below. In another alternate embodiment, the spacer ring 54 may be configured to fit around the circumference of the paint roller 20, 20a. Preferably the spacer ring 54 has a shoulder or edge surface that fits around the absorbent material. The spacer ring 54 in any such configuration is preferably configured to shield the end of absorbent material on the paint roller 20, 20a such that none of the absorbent material thereupon protrudes beyond the ring 54 once it is in place.

The ring 54 preferably has a plurality of ribs or grooves 56 around its perimeter and exposed or outward surface. The ribs or grooves 56 help to keep the end of the paint roller 20, 20a a minimum distance from any adjacent surface as described further below. Ideally, the ring 54 and ribs or grooves 56 do not maintain any paint thereupon or transfer any paint to the adjacent surface when in use. Alternatively, a user may wipe off any paint that may be on the ring 54 prior to applying the paint roller 20, 20a to any surface.

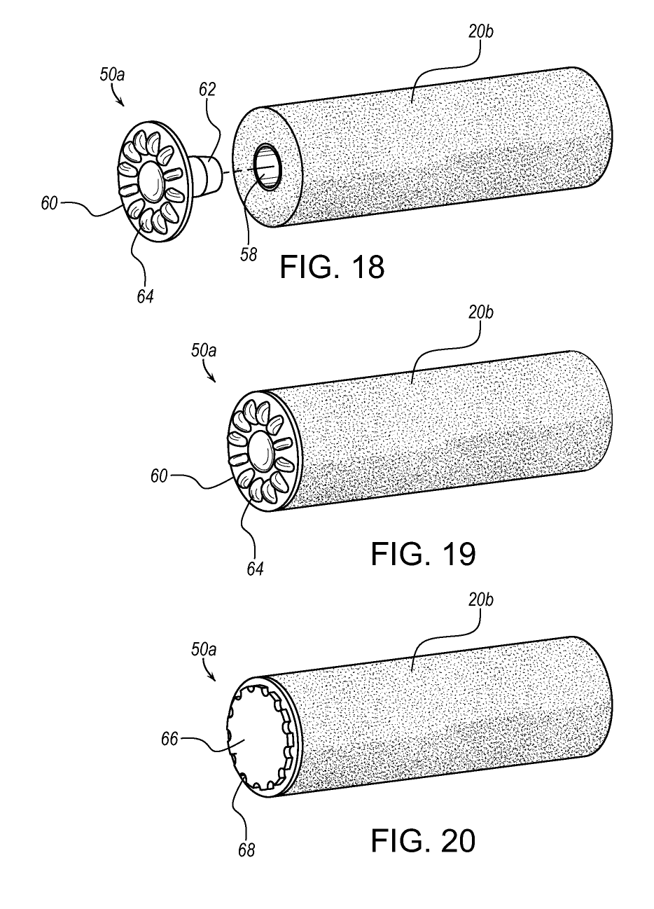

FIGS. 18-20 illustrate an alternate embodiment of the end cap 50a which is configured for use with a smaller diameter or mini paint roller 20b. This smaller diameter paint roller 20b is designed for use with mini roller frames, which rollers are known in the art. The smaller diameter paint rollers 20b have a narrow interior tube 58 configured to receive a rod from the frame in one end thereof. The other end of the narrow interior tube 58 may contain a small plug or be left open. The alternate end cap 50a has a flat disk 60 and a stem 62. The stem 62 is configured to be inserted into the end of the narrow interior tube 58. The stem 62 fits into the tube 58 preferably with a press, snap or friction fit, but may also be secured by other known mechanisms.

An exposed surface of the disk 60 may include a plurality of ribs 64 as shown in FIGS. 18 and 19. As with the embodiment described above, the ribs 64 help to keep the end of the roller 20b a minimum distance away from an adjacent surface. Alternatively, the exposed surface of the disk 60 may include a protruding surface 66 having a plurality of notches 68 around its perimeter as shown in FIG. 20. The protruding surface 66 helps to maintain the described minimum distance from an adjacent surface.

The end caps 50, 50a work more efficiently with rollers 20, 20a, 20b that have a ninety degree end relative to the length of the paint roller. This ensures that the absorbent material gets as close as possible to the adjacent surface to fill in paint up to the edge. Rollers 20, 20a, 20b with beveled ends may also be used but they will not get paint as close to the edge of the end cap 50, 50a, i.e., as far into the corner, as a ninety degree roller.

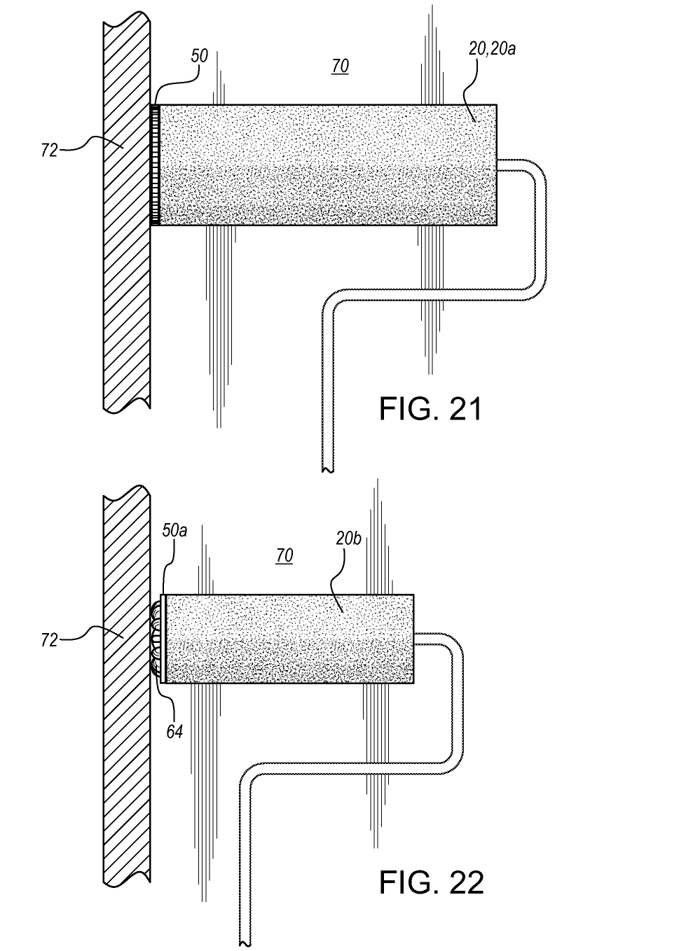

As mentioned previously, the end caps 50, 50a are designed to maintain a minimum distance between the end of the paint roller cover 20, 20a, 20b and an adjacent surface 72 when painting a target or painting surface 70, as illustrated in FIGS. 21 and 22. The adjacent surface 72 may comprise another wall as in a corner, a door jamb, along molding, or the side of a piece of furniture as a bookshelf, cabinet, or similar item. In use, a person would apply paint to the roller 20 as is typically done. Before applying the paint to the surface 70, one should make sure that no paint is on the end cap 50, 50a so as to the cause a transfer to the adjacent surface 72. This can be accomplished by visual inspection and use of a rag or other material to wipe off any paint that may have gotten onto the exposed surface of the end cap 50, 50a.

The painting surface 70 receives paint from the absorbent material covering the paint roller 20, 20a, 20b. The end cap 50, 50a maintains the minimum distance from the adjacent surface 72 through the spacing provided by the end cap 50, 50a and any attached spacing elements. Attached spacing elements can include the ribs/notches 56, the ribs 64, or the protruding disk 66. The attached spacing elements preferably have a thickness at least equivalent to or greater than the largest thickness of the paint being applied to the painting surface.

The attached spacing elements provide for less contact surfaces between the end cap 50, 50a and the adjacent surface 72. This reduction in contact surfaces minimizes the friction force resulting from such contact. An end cap 50, 50a that provides full surface contact with the adjacent surface 72 will have a higher friction force that will interfere with smooth and efficient rolling and paint application. The spacing elements reduce this possible friction force and do not hinder the smooth and efficient application of paint. As also described, the edge of the ring 54 or flat disk 60 provides a barrier to contain the absorbent material so that it does not protrude beyond the end cap 50, 50a.

Although several embodiments have been described in detail for purposes of illustration, various modifications may be made without departing from the scope and spirit of the invention. Accordingly, the invention is not to be limited, except as by the appended claims.

What is claimed is:

1. A paint roller end cap comprising:
a spacer cover configured for removable attachment to an exposed end of a paint roller cover;
means for removably attaching the spacer cover to the exposed end of the paint roller cover; and
a spacing extension disposed on an outward surface of the spacer cover, wherein the outward surface faces an adjacent surface to a painting surface.

2. The paint roller end cap of claim 1, wherein the spacer cover comprises an annular ring configured for removable attachment to an end plug in the exposed end of the paint roller cover.

3. The paint roller end cap of claim 2, wherein the end plug comprises a pressurized plug integral with the paint roller cover or an insertable plug, both configured for use with standard size paint roller covers.

4. The paint roller end cap of claim 2, wherein the means for removably attaching comprises an annular lip of the end plug extending from the exposed end of the paint roller cover and the annular lip is configured to receive the annular ring in a press fit or snap fit attachment.

5. The paint roller end cap of claim 2, wherein the spacing extension comprises a plurality of ribs or grooves disposed around the outward surface of the annular ring.

6. The paint roller end cap of claim 5, wherein the plurality of ribs or grooves have a predetermined depth configured to maintain the exposed end of the paint roller cover a minimum distance away from the adjacent surface.

7. The paint roller end cap of claim 1, wherein the spacer cover comprises a flat disk configured for removable attachment to a central tube on the paint roller cover.

8. The paint roller end cap of claim 7, wherein the central tube comprises an open cylinder on a mini paint roller cover.

9. The paint roller end cap of claim 7, wherein the means for removably attaching comprises a stem configured for press fit or snap fit attachment in the central tube.

10. The paint roller end cap of claim 7, wherein the spacer extension comprises a plurality of ribs annularly disposed around the outward surface of the flat disk.

11. The paint roller end cap of claim 7, wherein the spacer extension comprises a protruding disk extending from the outward surface of the flat disk.

12. The paint roller end cap of claim 11, further comprising a plurality of notches around a perimeter of the protruding disk.

13. A paint roller end cap comprising:
an annular ring spacer cover configured for removable attachment to an end plug disposed in an exposed end of a paint roller cover;
an annular lip of the end plug extending from the exposed end of the paint roller cover, the annular lip configured to receive the annular ring in a press fit or snap fit arrangement so as to removably attach the annular ring spacer cover to the exposed end of the paint roller cover; and
a plurality of ribs or grooves disposed on an outward surface of the annular ring spacer cover, wherein the outward surface faces an adjacent surface to a painting surface.

14. The paint roller end cap of claim 13, wherein the end plug comprises a pressurized plug integral with the paint roller cover or an insertable plug, both configured for use with standard size paint roller covers.

15. The paint roller end cap of claim 13, wherein the plurality of ribs or grooves have a predetermined depth configured to maintain the exposed end of the paint roller cover a minimum distance away from the adjacent surface.

16. A paint roller end cap comprising:
a flat disk spacer cover configured for removable attachment to a central tube on an exposed end of a paint roller cover;
a stem on the flat disk spacer cover configured for press fit or snap fit attachment to the central tube so as to removably attach the flat disk spacer cover to the exposed end of the paint roller cover; and
a spacing extension disposed on an outward surface of the spacer cover, wherein the outward surface faces an adjacent surface to a painting surface.

17. The paint roller end cap of claim 16, wherein the central tube comprises an open cylinder on a mini paint roller cover.

18. The paint roller end cap of claim 16, wherein the spacer extension comprises a plurality of ribs annularly disposed around the outward surface of the flat disk.

19. The paint roller end cap of claim 16, wherein the spacer extension comprises a protruding disk extending from the outward surface of the flat disk.

20. The paint roller end cap of claim 19, further comprising a plurality of notches around a perimeter of the protruding disk.
